(19) United States
(12) Patent Application Publication
(10) Pub. No.: US 2009/0008920 A1
(43) Pub. Date: Jan. 8, 2009

(54) ADJUSTABLE REAR FENDER ASSEMBLY

(76) Inventors: Kenneth T. Laivins, Hebron, OH (US); Glen A. Laivins, Hebron, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/774,197

(22) Filed: Jul. 6, 2007

(51) Int. Cl. B62D 25/16

(52) U.S. Cl. 280/847

(57) ABSTRACT

A fender assembly for a vehicle is provided. In one embodiment, the fender assembly includes a fender member, a clamp member, and a connecting member. In one embodiment, the connecting member is pivotally connected to the clamp member and detachably connected to the fender member such that the fender member is movable between at least a first position and a second position with respect to the connecting member. The fender assembly further includes a resistance member provided between the connecting member and the clamp member. The resistance member is configured to pivot the connecting member from a first position to a second position when a moment of force is applied to the connecting member above a predetermined threshold. The resistance member is further configured to bias the connecting member back to the first position when a moment of force is below the predetermined threshold.

### FIELD OF INVENTION

The present application relates to a fender assembly for a vehicle. In particular, the present application relates to an adjustable rear fender assembly for a vehicle, such as a bicycle, motorbike, motorcycle, motor scooter, or all-terrain vehicle (“ATV”).

### BACKGROUND

Fenders for bicycles, motorbikes, motorcycles, motor scooters, and ATVs are known in the art. Fenders are configured to protect a rider and bystanders from debris that adheres to the surface of a tire and is spun off into the air as the tire rotates. Fenders are also configured to protect tires of a vehicle from impacts with foreign objects.

Adjustable fenders configured to accommodate vehicles of different sizes are also known in the art. U.S. Pat. No. 6,199,883 discloses a removable fender that is selectively articulated in a vertical plane over the rear wheel. U.S. Pat. No. 6,913,274 discloses an adjustable fender composed of pivotally connected plates. Users may assemble the fender as desired, adjusting the shape and length.

### BRIEF DESCRIPTION OF THE DRAWINGS

The accompanying drawings, together with the detailed description provided below, describe exemplary embodiments of the claimed invention. Like elements are identified with the same reference numerals. The drawings are not to scale and the proportion of certain elements may be exaggerated for the purpose of illustration.

FIG. 1 is a partial side elevation view of one embodiment of a fender assembly mounted on a bicycle;

FIG. 2 is a side elevation view of one embodiment of a fender assembly;

FIG. 3 is a side elevation view of one embodiment of a connecting member and a portion of a mounting member of a fender assembly;

FIG. 4 is an exploded perspective view of one embodiment of a connecting member and a portion of a mounting member of a fender assembly;

FIG. 5 is an exploded perspective view of one embodiment of a mounting member of a fender assembly;

FIG. 6 is a perspective view of a connecting member and an alternative embodiment of a resistance member; and

FIGS. 7A-B are side elevation view of one embodiment a fender assembly with a fender member in first and second positions.

### DETAILED DESCRIPTION

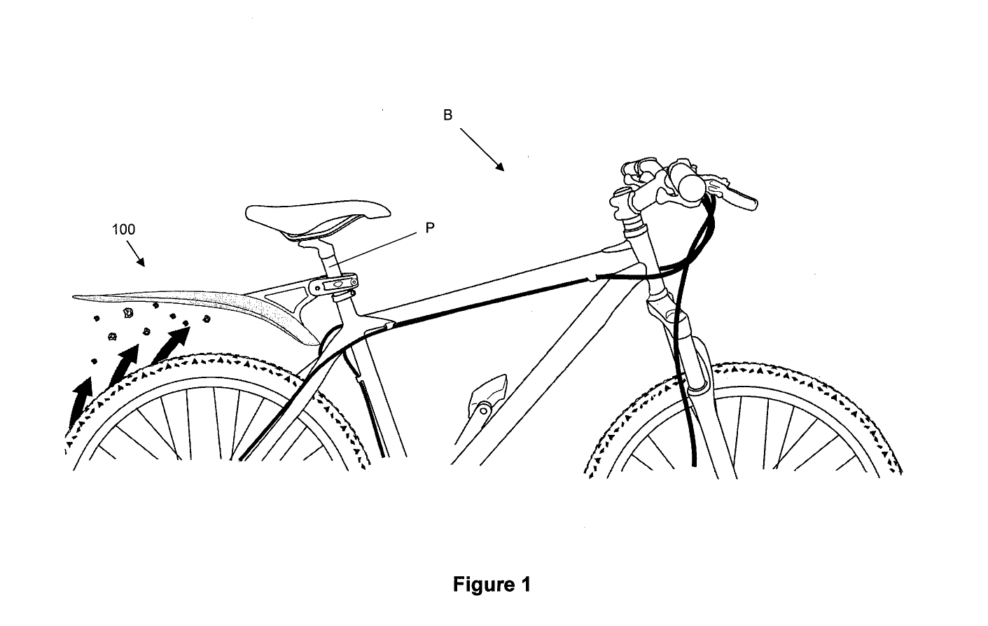

FIG. 1 illustrates a partial side elevation view of one embodiment of a fender assembly 100 mounted on a bicycle B. In this embodiment, the fender assembly 100 is mounted on a seat post P of the bicycle B. In an alternative embodiment, the fender assembly 100 may be mounted on another component of the bicycle B. In other alternative embodiments, the fender assembly 100 may be employed on a motorcycle, motor scooter, motorbike, ATV, or any other vehicle.

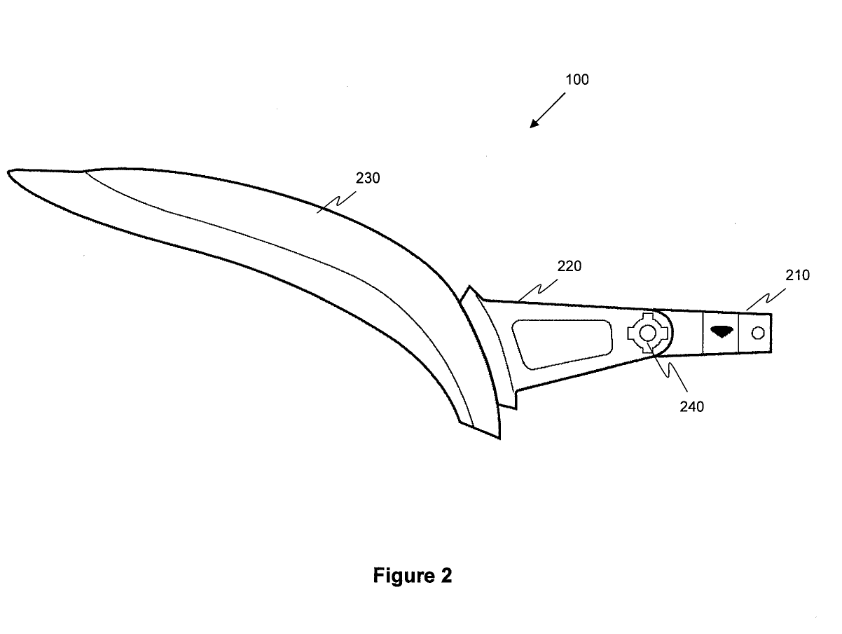

FIG. 2 illustrates a side elevation view of the fender assembly 100. In the illustrated embodiment, the fender assembly includes a mounting member 210, a connecting member 220, and a fender member 230. In the illustrated embodiment, the connecting member 220 has a first end connected to the mounting member 210 and a second end connected to the fender member 230.

In one embodiment, the mounting member 210, the connecting member 220, and the fender member 230 are each constructed of a polymeric material. Exemplary polymeric materials include, without limitation, polypropylene, polyethylene, ethylene propylene diene monomer (EPDM) rubber, or a combination thereof. In one embodiment, the mounting member 210, the connecting member 220, and the fender member 230 are each constructed of the same material. In an alternative embodiment, the mounting member 210, the connecting member 220, and the fender member 230 are constructed of different material. In an alternative embodiment (not shown), at least one of the mounting member 210, the connecting member 220, and the fender member 230 is constructed of metal. In another alternative embodiment (not shown), the connecting member 220 is constructed of nylon. In yet another alternative embodiment (not shown), each of the mounting member 210, connecting member 220, and fender member 230 are constructed of nylon.

The mounting member 210 is configured to be mounted to a vehicle. In the illustrated embodiment, the mounting member 210 is a clamp member configured to be clamped to a seat post of a bicycle or other vehicle. In alternative embodiments (not shown), the mounting member is a fork, flange, or other fastener configured to be connected to a frame of a bicycle or other vehicle.

In the illustrated embodiment, the connecting member 220 is a substantially triangularly shaped component configured to be connected to the mounting member 210 and the fender member 230. In alternative embodiments (not shown), the connecting member 220 may be a rod, bar, or any other intermediate member, including single component members and multiple component members.

As shown in FIG. 2, the connecting member 220 is pivotally connected to the mounting member 210 by a resistance member 240 and the connecting member 220 is rigidly connected to the fender member 230.

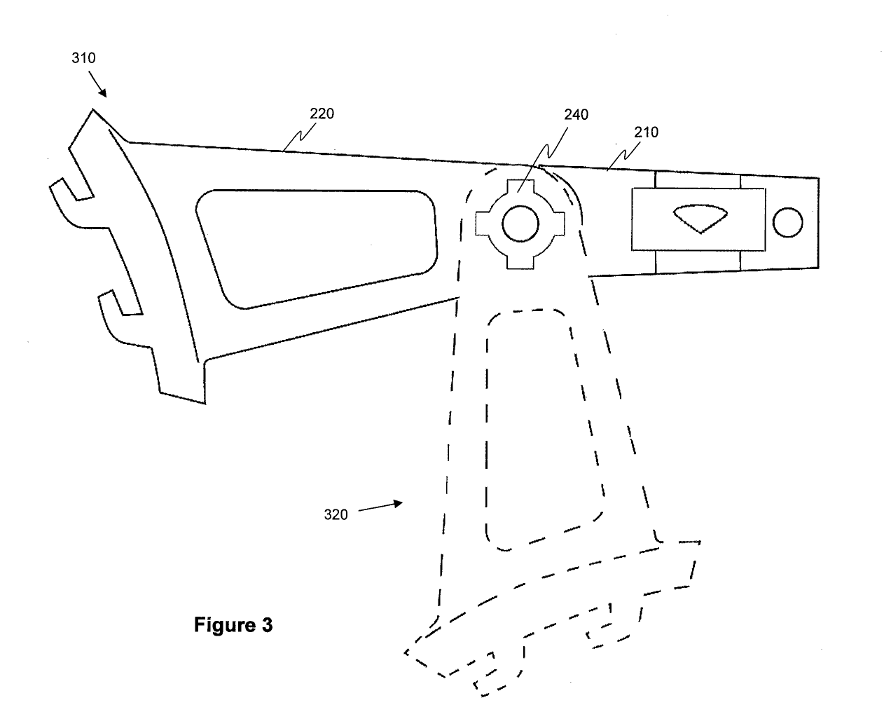

FIG. 3 illustrates a side elevation view of the mounting member 210 and the connecting member 220. As shown in the illustrated embodiment, the resistance member 240 is configured to permit the connecting member 220 to selectively pivot from a first position 310 to a second position 320 when a moment of force above a predetermined threshold is applied to the connecting member 220. The resistance member 240 is further configured to provide resistance, and thereby bias the connecting member 220 back towards the first position when the connecting member 220 is in the first position and a moment of force below the predetermined threshold is applied to the connecting member 220.

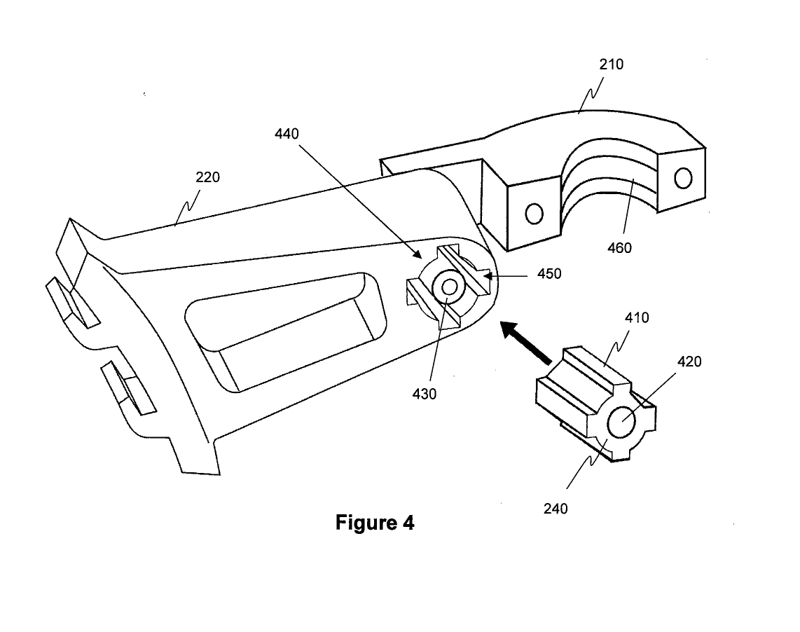

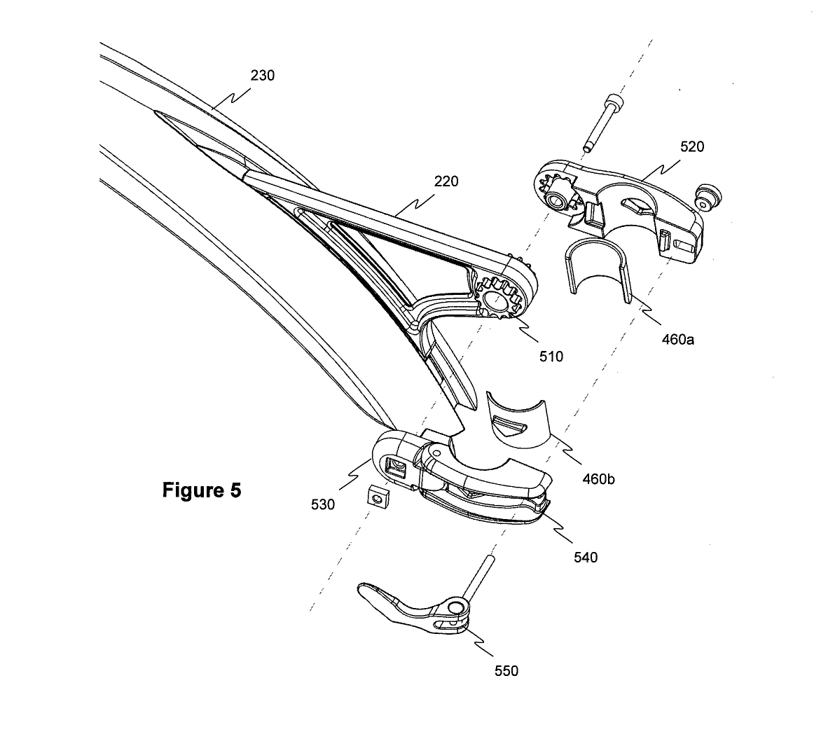

FIG. 4 illustrates a partially exploded perspective view of the mounting member 210, the connecting member 220, and the resistance member 240. In the illustrated embodiment, the resistance member 240 is an elastomeric, cylindrically-shaped member having a plurality of teeth 410 and an aperture 420. The resistance member 240 may be constructed of any elastomeric material, including, without limitation, natural rubber, butyl rubber, styrene-batadiene rubber, nitrile rubber, chlororene rubber, ethylene propylene rubber, ethylene propylene diene rubber, silicone rubber, polyether rubber, thermoplastic elastomers, and other known elastomers. For illustrative purposes, the resistance member 240 is shown with four teeth. In another embodiment (illustrated in FIG. 5), the resistance member 240 has twelve teeth. In alternative embodiments, the resistance 240 member may have any number of teeth.

With continued reference to FIG. 4, the mounting member 210 includes a projection 430 configured to be received in the aperture 420 of the resistance member 240. In the illustrated embodiment, the projection 430 is a cylindrically-shaped rod. In alternative embodiments, the projection 430 has an oval, square, rectangular, or other polygonal cross-section, and the aperture 420 has correspond cross-section. In other alternative embodiments, the projection 430 has a cross-section defined by any combination of straight or curved lines, and the aperture 420 has a corresponding shape.

In one embodiment, the resistance member 240 is fixedly attached to the projection 430. Exemplary means for fixedly attaching the resistance member 240 to the projection 430 include glue, epoxy, other adhesives, bolts, screws, and pins. In an alternative embodiment, the projection 430 may include fins or other projections that hold the resistance member 240 in place. In another alternative embodiment (not shown), the mounting member 210 does not include a projection, and the resistance member 240 is directly attached to the mounting member.

With continued reference to FIG. 4, the connecting member 220 has an aperture 440 with grooves 450 corresponding to the teeth 410 of the resistance member 240. In the illustrated embodiment, the aperture 440 includes four grooves 450 that correspond with the four teeth 410. In alternative embodiments, the aperture 440 of the connecting member 220 has any number of grooves 450, correspond to the number of teeth 410 of the resistance member 240 on a 1:1 ratio. In another alternative embodiment, the aperture 440 of the connecting member 220 has more grooves 450 than the number of teeth 410 of the resistance member 240. In one such embodiment, the aperture 440 of the connecting member 220 has twice as many grooves 450 as the number of teeth 410 of the resistance member 240.

In the illustrated embodiment, the resistance member 240 and the aperture 440 of the connecting member 220 are configured such that the teeth 410 of the resistance member 240 mesh with the corresponding grooves 450 of the aperture 440 of the connecting member 220. The connecting member 220 is initially in a first position with respect to the mounting member 210. The connecting member 220 will have a number of stable positions with respect to the mounting member 210. The number of stable positions will correspond to the number of grooves 450 in the aperture 440.

When a moment of force is applied to the connecting member 220, the sides of the grooves 450 of the aperture 440 will contact the teeth 410 of the resistance member 240. The teeth 410 will provide resistance against the moment of force. If the moment of force is below a predetermined threshold, the resistance member 240 will bias the connecting member 220 back towards the first position, according to the physical properties of the elastomeric material used to construct the resistance member 240. If the moment of force is above the predetermined threshold, the teeth 410 of the resistance member 240 will pivot from the corresponding grooves 450 of the aperture 440 until the teeth 410 reach the adjacent grooves. If the moment of force is still being applied and is still greater than the predetermined threshold, the teeth 410 will continue to pivot. If the moment of force is no longer applied, or is no longer above the predetermined threshold, the connecting member 220 will remain in the new position.

In one embodiment, the material and shape of the resistance member 240 may be selected such that the predetermined threshold is at a level that would allow an average user to adjust the position of the connecting member 220 by hand without undue exertion, but that ordinary debris would not cause the connecting member 220 to change position.

In an alternative embodiment (not shown), the resistance member is fixed with respect to the connecting member, and the mounting member has an aperture with grooves corresponding to the teeth of the resistance member. In another alternative embodiment (not shown), the resistance member includes a ratchet and pawl assembly. In other alternative embodiments (not shown), the resistance member includes one of a torsion spring, a spring, and a piston and cylinder.

With continued reference to FIG. 4, the mounting member 210 further includes an elastomeric insert 460 configured to be inserted in an opening of the mounting member 210. The elastomeric insert 460 may be constructed of any elastomeric material, including, without limitation, natural rubber, butyl rubber, styrene-batadiene rubber, nitrile rubber, chlororene rubber, ethylene propylene rubber, ethylene propylene diene rubber, silicone rubber, polyether rubber, thermoplastic elastomers, and other known elastomers. In one embodiment, a pliable material is selected for the elastomeric insert 460, such that it conforms to a seat post or other component of a vehicle, thereby allowing the mounting member 210 to attach to vehicles of different sizes. A material having a high coefficient of friction may also be selected for the elastomeric insert 460, to prevent the mounting member 210 from sliding on the vehicle.

FIG. 5 illustrates an exploded perspective view of an alternative embodiment of a mounting member 500, configured to be connected to a connecting member 220. In the illustrated embodiment, a resistance member 510 having twelve teeth is illustrated. It should be understood that the resistance member may employ any number of teeth. In the illustrated embodiment, the connecting member 220 includes an aperture with grooves corresponding to the teeth of the resistance member, as described above in relation to FIG. 4. However, in the illustrated embodiment, each side of the mounting member 500 also includes a recess 520 having grooves 530 corresponding to the teeth of the resistance member 510. In this embodiment, the teeth resistance member 510 provide resistance against both the connecting member 220 and the mounting member 500.

With continued reference to FIG. 5, the mounting member 500 is a clamp member that includes a solid clamp portion 540, a complementary solid clamp portion 550, a pivoting clamp portion 560, and a locking member 570. In the illustrated embodiment, the complementary solid clamp portion 550 is configured to be connected to and to be fixed with respect to the solid clamp portion 540. The pivoting clamp portion 550 is configured to be pivoted with respect to the complementary solid clamp portion 550, such that it contacts the solid clamp portion 540 when placed in a closed position. The locking member 570 is configured to lock the mounting member 500 in the closed position when the fender assembly is placed in a desired position with respect to a vehicle.

In the illustrated embodiment, the solid clamp portion 510 and the pivoting clamp portion 520 each include an elastomeric insert 460, as described above. In an alternative embodiment, the mounting member 210 does not include elastomeric inserts.

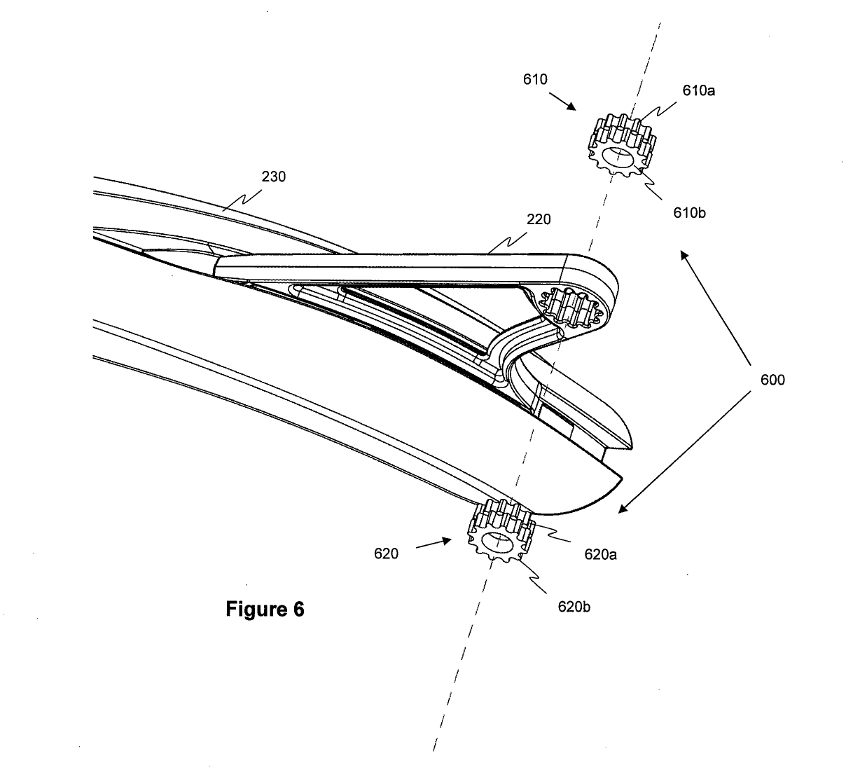

FIG. 6 illustrates a perspective view of a fender assembly having an alternative embodiment of a resistance member 600. In the illustrated embodiment, the resistance member 600 includes a first resistance component 610 and a second resistance component 620. The first resistance component 610 includes a first half 610a and a second half 610b. Similarly, the second resistance component 620 includes a first half 620a and a second half 620b.

In the illustrated embodiment, the first half 610a of the first resistance component 610 is an elastomeric component having a number of teeth, similar to the resistance members 240, 510 described above. In the illustrated embodiment, the first half 610a has twelve teeth, but it should be understood that the first half 610a may have as many teeth as desired. The teeth of the first half 610a are configured to engage the grooves of a recess in the mounting member (not shown). The second half 610b of the first resistance component 610 is also an elastomeric member having a number of teeth, similar to the resistance members 240, 510 described above. In the illustrated embodiment, the second half 610b also has twelve teeth, but the teeth are offset from the teeth from the teeth of the first half 610a. The teeth of the second half 610b are configured to engage the grooves of the aperture of the connecting member 220. In an alternative embodiment (not shown) the second half 610b has a different number of teeth than the first half 610a.

With continued reference to FIG. 6, the second resistance component 620 is substantially the same as the first resistance component 610. Because the teeth of the first and second half of each resistance component are offset, the mounting member (not shown) may be disposed at a different angles relative to the connecting member 220 than it would be when a solid resistance member is used.

In one known embodiment, the fender assembly is distributed as a kit having a plurality of resistance members, including at least one solid resistance member (such as resistance member 240 or 510) and at least one resistance member having offset components (such as the resistance member 610). In this embodiment, a user may select a resistance member to position the fender member as desired.

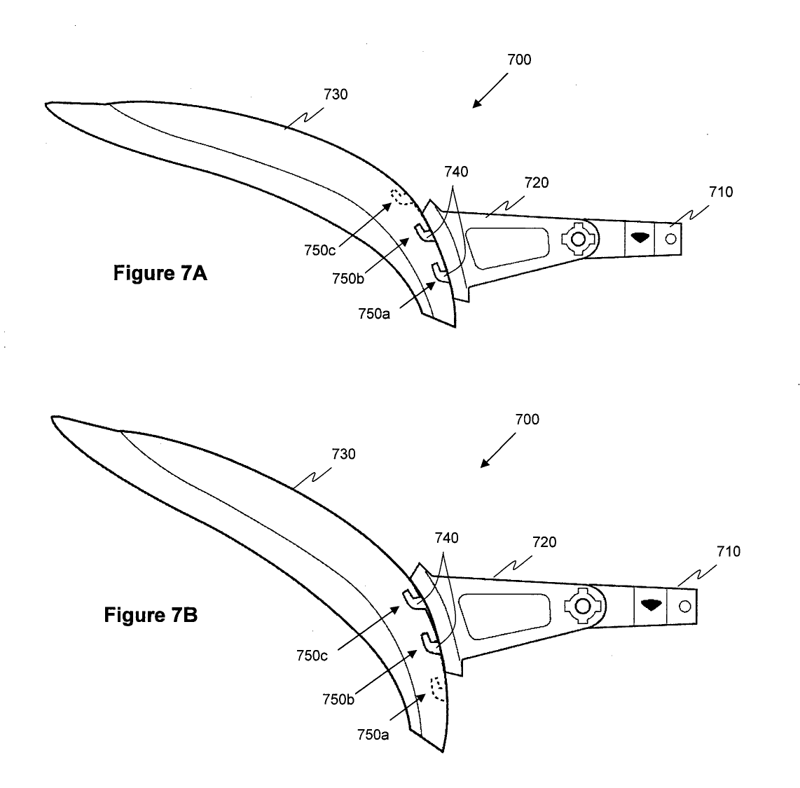

FIGS. 7A and 7B illustrate side elevation views of an alternative embodiment of a fender assembly 700. In the illustrated embodiment, the fender assembly includes a mounting member 710, a connecting member 720, and a fender member 730. In the illustrated embodiment, the connecting member 720 has a first end connected to the mounting member 710 and a second end connected to the fender member 730.

In the illustrated embodiment, the mounting member 710 is pivotally connected to the connecting member 720, in the manner described above with respect to FIGS. 3 and 4. In the illustrated embodiment, the connecting member 720 is detachably connected to the fender member 730. FIG. 7A shows the connecting member 720 attached to the fender member 730 in a first position. FIG. 7B shows the connecting member 720 attached to the fender member 730 in a second position. While only two positions are illustrated, it should be understood that the connecting member 720 may be connected to the fender member 730 in three or more positions.

As shown in FIG. 7A, the connecting member 720 includes projections 740 and the fender member 730 includes a plurality of apertures 750a,b,c configured to receive the projections 740. In the illustrated embodiment, the projections 740 are rigid, hook-shaped projections and the apertures 750a,b,c have a corresponding hook shape. In an alternative embodiment, the apertures 750a,b,c are simple openings having a circular, oval, square, or other regular or irregular shape. In an alternative embodiment (not shown), the projections are rotatable T-shaped projections and the apertures in the fender member 730 are slots. In such an embodiment, the T-shaped projections may be inserted into the slot-shaped apertures, and then rotated to be locked into place. In another alternative embodiment (not shown), the connecting member 720 has apertures instead of projections. In such an embodiment, the apertures of the connecting member may be aligned with the apertures of the fender member, so that the connecting member may be fastened to the fender member by a fastener, such as a screw, bolt, pin, nail, or other known fastener.

In the illustrated embodiment, the connecting member 720 includes two projections 740 and the fender member 730 includes three apertures 750a,b,c. In the illustrated embodiment, the projections 740 are received by lower aperture 750a and middle aperture 750b, such that the connecting member 720 is in a first position with respect to the fender member 730. In FIG. 7B, the projections 740 are received by middle aperture 750b and upper aperture 750c, such that the connecting member 720 is in a second position with respect to the fender member 730.

In an alternative embodiment (not shown), the connecting member 720 includes a single projection. In another alternative embodiment (not shown), the connecting member 720 includes three or more projections. In all cases, the fender member 730 has at least as many apertures as the connecting member 720 has projections. In other embodiments, the fender member 730 has additional apertures to define additional positions. In an alternative embodiment (not shown), the fender member 730 has projections and the connecting member 720 has apertures configured to receive the projections.

In another alternative embodiment (not shown), the connecting member includes an elongated projection, and the fender includes a rail configured to receive the elongated projection. The elongated projection may slide along the rail among a plurality of positions. Such an embodiment may additional include a locking mechanism to lock the elongated projection in a selected position along the rail. In yet another alternative embodiment (not shown), the fender member includes an elongated projection and the connecting member includes a rail configured to receive the elongated projection. In another alternative embodiment, the connecting member is omitted and the fender member is configured to be directly connected to the mounting member.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

1. A fender assembly for a vehicle, the fender assembly comprising:
a fender member;
a clamp member configured to be attached to the vehicle;
a connecting member pivotally connected to the clamp member and detachably connected to the fender member such that the fender member is movable between at least a first position and a second position with respect to the connecting member; and
a resistance member provided between the connecting member and the clamp member and configured to pivot the connecting member from a first position to a second position when a moment of force is applied to the connecting member above a predetermined threshold, and further configured to bias the connecting member to the first position when the connecting member is in the first position and a moment of force is applied to the connecting member below the predetermined threshold.

2. The fender assembly of claim 1, further comprising an elastomeric insert configured to be inserted in an opening of the clamp member.

3. The fender assembly of claim 1, wherein the resistance member is an elastomeric cylindrically shaped member having a plurality of teeth configured to mesh with corresponding grooves in one of the connecting member and the clamp member.

4. The fender assembly of claim 3, wherein the teeth of the resistance member are configured to pivot from the corresponding grooves to adjacent corresponding grooves when a moment of force is applied to the connecting member above the predetermined threshold.

5. The fender assembly of claim 3, wherein the teeth of the resistance member are configured to provide resistance sufficient to retain the teeth in the corresponding grooves when a moment of force is applied to the connecting member below the predetermined threshold.

6. The fender assembly of claim 1, wherein the vehicle is one of a motorbike, motorcycle, motor scooter, bicycle, and an all-terrain vehicle and the clamp member is configured to be attached to a seat post.

7. The fender assembly of claim 1, wherein the fender member includes a plurality of apertures configured to receive a corresponding portion of the connecting member.

8. The fender assembly of claim 1, wherein the fender member is slidably connected to the connecting member.

9. A kit for a fender assembly configured to be connected to a vehicle, the kit comprising:
a fender;
a mounting member;
an intermediate member configured to be connected to the fender and pivotally connected to the mounting member;
a resistance member configured to perform at least one of a biasing and pivoting function according to a level of a moment of force applied.

10. The fender assembly kit of claim 9, further comprising an elastomeric sleeve configured to be received by the mounting member.

11. The fender assembly kit of claim 9, wherein the mounting member is a clamp.

12. The fender assembly kit of claim 9, wherein the resistance member is an elastomeric cylindrically shaped member having a plurality of teeth.

13. The fender assembly kit of claim 9, wherein the resistance member includes at least two elastomeric cylindrically shaped members, each having a plurality of teeth.

14. The fender assembly kit of claim 9, wherein the intermediate member is configured to be detachably connected to the fender.

15. A fender assembly comprising:
a mounting member;
a fender member;
a connecting member; and
a resistance member provided between the connecting member and the mounting member and configured to pivot the connecting member from a first position to a second position when a moment of force is applied to the connecting member above a predetermined threshold, and further configured to bias the connecting member to the first position when the connecting member is in the first position and a moment of force is applied to the connecting member below the predetermined threshold.

16. The fender assembly of claim 15, wherein the resistance member is an elastomeric cylindrically shaped member having a plurality of teeth.

17. The fender assembly of claim 16, wherein the teeth of the resistance member are configured to mesh with corresponding grooves in at least one of the mounting member and the connecting member, and are further configured to pivot from the corresponding grooves to adjacent corresponding grooves when a moment of force is applied to the connecting member above the predetermined threshold.

18. The fender assembly of claim 16, wherein the teeth of the resistance member are configured to mesh with corresponding grooves in at least one of the mounting member and the connecting member, and are further configured to provide resistance sufficient to retain the teeth in the corresponding grooves when a moment of force is applied to the connecting member below the predetermined threshold.

19. The fender assembly of claim 16, wherein the connecting member is detachably connected to the fender member such that the fender member is movable between at least a first position and a second position with respect to the connecting member.

20. The fender assembly of claim 15, wherein the resistance member is rigidly attached to the mounting member.
